(19) United States
(12) Patent Application Publication
(10) Pub. No.: US 2009/0083238 A1
(43) Pub. Date: Mar. 26, 2009

(54) STOP-AND-RESTART STYLE EXECUTION FOR LONG RUNNING DECISION SUPPORT QUERIES

(75) Inventors: Surajit Chaudhuri, Redmond, WA (US); Shriraghav Kaushik, Redmond, WA (US); Abhijit Pol, Santa Clara, CA (US); Ravishankar Ramamurthy, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/859,046

(22) Filed: Sep. 21, 2007

(51) Int. Cl. G06F 17/30

(52) U.S. Cl. 707/4; 707/E17.014

(57) ABSTRACT

Stop-and-restart query execution that partially leverages the work already performed during the initial execution of the query to reduce the execution time during a restart. The technique selectively saves information from a previous execution of the query so that the overhead associated with restarting the query execution can be bounded. Despite saving only limited information, the disclosed technique substantially reduces the running time of the restarted query. The stop-and-restart query execution technique is constrained to save and reuse only a bounded number of records (intermediate records or output records) thereby releasing all other resources, rather than some of the resources. The technique chooses a subset of the records to save that were found during normal execution and then skipping the corresponding records when performing a scan during restart to prevent the duplication of execution. A skip-scan operator is employed to facilitate the disclosed restart technique.

### BACKGROUND

Long running decision support queries can be resource intensive and oftentimes lead to resource contention in data warehousing systems. For example, recent TPC-H (transaction processing performance council—type H) benchmark results show that these queries can take hours to execute on large datasets due to query complexity and, hardware and/or software limitations of the system. In more robust systems that include multi-processor or multi-threaded pipelines, this can be due in part to multiple long running queries that execute concurrently competing for limited resources including CPU time, main memory space, and workspace area on mass storage devices used to store temporary results, sort runs and spilled hash partitions. Thus, contention for valuable resources can substantially increase the execution times of the queries.

It is possible to suspend the execution threads of one or more low-priority queries and resume these threads at a later time. The main problem with this approach is that suspending the execution of a query only releases the CPU resources; the memory and disk resources are still retained until the query execution thread is resumed. Thus, the only real option available to database administrators in order to release all resources is to carefully select and then terminate one or more of the low-priority queries (e.g., based on criteria such as the importance of the query or the amount of resources used by it or progress information), thereby releasing all resources allocated to the terminated queries, which then can be used to complete other queries.

In conventional database systems, the work performed by the terminated queries is lost even if the queries were very close to completion. The queries will then need to be entirely re-run at a later time. Any attempt to save and reuse all intermediate results potentially requires very large memory and/or disk resources (e.g., hash tables in memory, sort runs in disk, etc.) in the worst case, amounting to significant processing overhead.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture employs stop-and-restart query execution that can partially leverage the work already performed during the initial execution of the query to reduce the execution time during a restart. Despite saving only limited information, the disclosed technique can substantially reduce the running time of the restarted query.

In other words, the stop-and-restart query execution technique is constrained to save and reuse only a bounded number of records (intermediate records or output records) thereby releasing all other resources, rather than some of the resources. The technique chooses to save a subset of the records processed during normal execution and then skipping the corresponding records when performing a scan during restart to prevent the duplication of execution.

A generalization of a scan operator called skip-scan is employed to facilitate the disclosed restart technique. The technique selects the subset of records online as query execution proceeds, without having knowledge of when, or if at all, the query will be terminated. The skip-scan operator can also be extended to skip multiple contiguous ranges of records.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented system for stop-and-restart query execution.

FIG. 2 illustrates examples of single pipeline query execution plans that can be processed by skipping previously selected and saved state.

FIG. 3 illustrates a diagram of a skip-scan operator for skipping source records when scanning a source during the restart run for the plan of FIG. 2.

FIG. 4 illustrates an optimal bounded restart plan where the budget k is three.

FIG. 5 illustrates a computer-implemented method of executing a query.

FIG. 6 illustrates an exemplary Opt-Skip algorithm.

FIG. 7 illustrates an execution plan with multiple pipelines.

FIG. 8 illustrates a method of maintaining a maximal benefit for restart plans.

FIG. 9 illustrates a block diagram of a computing system operable to execute the disclosed stop-and-restart execution plan architecture.

### DETAILED DESCRIPTION

The disclosed architecture facilitates a stop-and-restart style of query execution that is constrained to save and reuse only a bounded number of records (intermediate records or output records), thereby limiting the resources retained by a query that has been terminated. This will be referred to herein as the bounded query checkpointing problem. The architecture provides methods for choosing a subset of records to save during normal query execution and then skipping the corresponding records when performing a scan during restart. Selection is performed without any knowledge of query termination, if the query will be terminated at all.

One suitable application of the stop-and-restart style execution is decision-support queries issued in a data-warehousing environment. In this context, it is assumed that the database is read-only, except for a batched update window of operation when no queries are executed.

The stop-and-restart style of query execution is described around query execution plans. A query execution plan is a tree where nodes of the tree are physical operators. Each operator exposes a “get next” interface and query execution proceeds in a demand-driven fashion. An operator is called a blocking operator if the operator produces no output until it consumes at least one of its inputs completely. A hash join is an example of blocking operator. A probe phase cannot begin until the entire build relation is hashed.

A pipeline is a maximal subtree of operators in an execution plan that execute concurrently. Every pipeline has one or more source nodes, a source node being the operator that is the source of the records operated upon by remaining nodes in the pipeline. A table scan and an index scan are examples of source nodes. Execution plans comprising multiple pipelines are also described infra.

One natural candidate for measuring the amount of work done during query execution is the optimizer cost model; however, a more light-weight alternative can be employed. This light-weight method is to use the total number of GetNext calls measured over all the operators to model the work done during query execution. While a weighted aggregation of GetNext calls is more appropriate for complex queries involving operations such as subqueries and user-defined functions (UDFs), the count can be is used as a first step.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

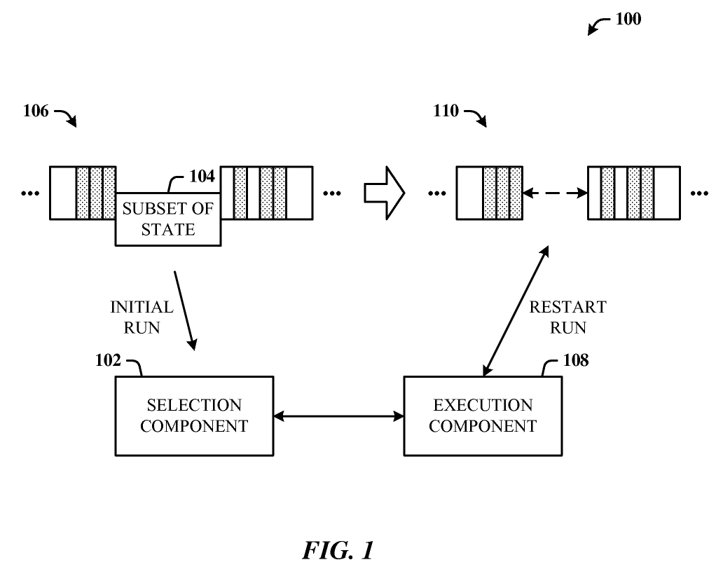

Referring initially to the drawings, FIG. 1 illustrates a computer-implemented system 100 for stop-and-restart query execution. Stop-and-restart style query execution involves two distinct phases: an initial run which is the first query execution until it is terminated, and a restart run which is the re-execution of the same query at a later time. (Restart can also be referred to as a resumption of the query.) Some state is saved during the initial run which can be utilized during the restart run. When the query is killed, this state is saved in combination with a modified execution plan (also referred to as a restart plan) that utilizes the state. During the restart run, the modified plan is executed.

Accordingly, the system 100 includes a selection component 102 for selecting a subset 104 of state 106 associated with an initial run of a query that is abnormally terminated. An execution component 108 restarts execution (a restart run) of the query based on a restart execution plan 110 (also referred to as a restart plan) and skips execution of the subset 104.

In one embodiment, the subset 104 of the state 106 (also referred to herein as a set of intermediate records or results) generated during the initial run is stored. Other candidate state that can be saved include the internal state of operators (e.g., hash tables and sort runs) which will be described herein. Additionally, the storage constraint can be given in terms of the number of bytes, or specified in terms of the number of records, as will be used herein.

Properties of the stop-and-restart style execution include correctness where the restart plan is equivalent to the original query plan. Another property is low overhead. There can be two forms of overhead in the stop-and-restart framework. A first form is the monitoring overhead incurred when the query is not terminated. The performance in this case should be comparable to normal query execution. A second form of overhead is the stop-response-time, which is the time taken to terminate the query. The process of query termination is fast, which then constrains the number of records that can be saved. Another property is generality: the stop-and-restart framework is applicable to a wide range of query execution plans. Yet another property is the efficiency of the restart. The sum of the execution time before the query is stopped and the execution time after the query is restarted is as close as possible to the execution time of uninterrupted query execution. Thus, a performance metric is how much of the work done during the initial run can be saved during the restart run.

Note that although illustrated as a single pipeline query, the system 100 can process multiple skip-scan operators in the pipeline as well as multiple pipelines that use multiple skip-scan operators. Moreover, the skip-scan operator can be extended to skip multiple contiguous ranges of records. With respect to a generalized skip-scan operator, after the query is terminated, the restart plan can potentially be used to restart the query in another replica of the database system (as long as the database system has the identical database). Additionally, the restart plan can be migrated to another machine for execution.

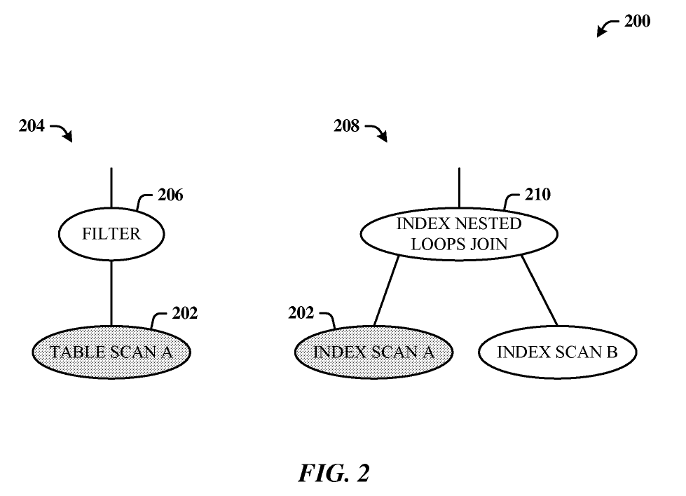

FIG. 2 illustrates examples of single pipeline query execution plans 200 that can be processed by skipping previously selected and saved state. Pipelines that include a single source node and where the results of the pipeline are obtained by invoking the operator tree on each source record in order and taking the union, can be employed. The plans 200 fall in this class, where the source nodes 202 are shaded. Result records are generated at the root node of the pipeline. At any point in execution, it is meaningful to refer to the current source record being processed in the pipeline. There are pipelines having operators such as Top, Merge-Join that do not fall in this class; however, the disclosed techniques are applicable to such pipelines. Additionally, query execution plans comprising multiple pipelines are described infra.

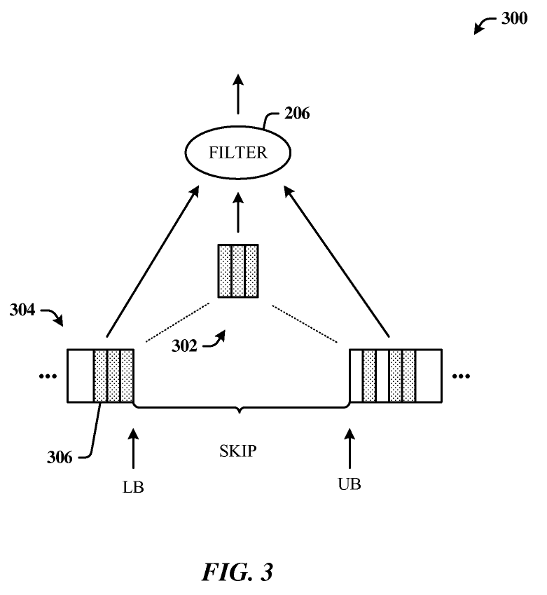

For example, for a first plan 204, all records returned by the Filter operator 206 are saved. During the restart run, the goal is to avoid re-computing these saved results. This is accomplished by introducing the notion of skipping the corresponding source records when scanning the source in the restart run. Similarly, this applies for a second plan 208 where all records returned by the Index Nested Loops Join operator 210 are saved. This will be described in more detail according to an alternative representation in FIG. 3.

FIG. 3 illustrates a diagram 300 of a skip-scan operator for skipping source records 302 when scanning a source 304 during the restart run for the plan 204 of FIG. 2. The simplest stop-restart technique is to save all result records generated during the initial run at the root of the pipeline. During the restart run, the goal is to avoid re-computing these saved results. This is accomplished by introducing the notion of skipping the corresponding source records 302 when scanning the source 304 in the restart run.

The description assumes that each source record (R) 306 has a unique record identifier (RID). This can be implemented by adding a primary key value to the key of a clustering index, for example. Without loss of generality, it is assumed that RIDs are numbered 1, 2, 3 . . . in the order in which the RIDs are scanned. For ease of exposition, a special RID value of zero indicates the beginning of the table. The skipped records 302 are delineated in the source 304 by a lower bound (LB) and an upper bound (UB). The notation (LB, UB) (using parenthesis) denotes all source records with RIDs between the LB and UB, but not including the LB and UB, whereas [LB, UB] (using brackets) also includes LB and UB. It is also assumed that for any intermediate record IR (also called the skipped records 302), the RID for the corresponding source record can be obtained, denoted as Source(r).

Following is a generalized version of a scan operator primitive that can be used to support this. The scan operator takes two RIDs LB<UB as an input. The operator scans all records in the source node up to and including LB, and resumes the scan from the record with RID UB (included in the scan), skipping all records inbetween.

The skip-scan operator can be built on top of existing operators such as Table Scan and Clustered Index Scan utilizing the random access primitives from the storage manager. For instance, in a Clustered Index Scan, the UB value is sought using the key. In the case of Heap File Scan, the page information (pageID, slotID) is remembered from which to resume the scan. Although described thus far as skipping a single contiguous range of source records, in general, the skip-scan operator can be extended to skip multiple portions of the source node.

All operators can be extended with the ability to save a sequence of records. This logic is invoked at the root of the pipeline, and detected at compilation time. If and when the query is terminated, a restart plan that uses this sequence of records is saved, where the source node is replaced with a corresponding skip-scan operator.

Following is an explanation for the execution of the restart plan. Consider the point where the skip-scan operator has returned to the source record corresponding to LB. At this point, similar to an end-of-stream (EOS) message that a scan operator sends at termination, the skip-scan operator sends an end-of-LB (EOLB) message before skipping to the UB. On receiving the EOLB message, the pipeline root returns the saved records, after which the root invokes its child operator, as usual. In FIG. 3, the Filter operator 206 is the root of the pipeline which returns the three skipped and saved source records 302 on receiving the EOLB message from the skip-scan operator.

Given a pipeline P, any pair of RIDs LB<UB (at the source node) identifies a restart plan RPlan(LB,UB) as follows. The scan of the source node is replaced with a skip-scan operator seeded with LB and UB, and the results generated by records in the region (LB,UB) are saved at the root of the pipeline. This plan is equivalent to P. Recall from above that the cost of a plan can be measured in terms of the number of GetNext calls completed in the course of plan execution. For ease of exposition, the GetNext calls involved in returning the results cached at the root of the pipeline of a restart plan are ignored. However, the results extend even when counting these calls.

Instead of reasoning in terms of cost, the notion of benefit of a restart plan is introduced where the benefit of a restart plan is the number of GetNext calls skipped (that is, the difference between the number of GetNext calls completed while executing the original plan and the restart plan).

Recall from above that result records are cached at the root of the pipeline. This provides motivation to search the space of restart plans by examining result records (at the root). For a window W that includes contiguous result records rᵢ₋ᵢ, . . . , rᵢ₊ⱼ (i≧0) at the root of the pipeline, the corner records rᵢ₋₁, and rᵢ₊ⱼ are used to derive a restart plan, as follows. The set of result records (or intermediate result records) excluding the two corners, that is rᵢ, . . . , rᵢ₊ⱼ₋₁ is called the candidate setunderlying W with size j. By setting LB=Source(rᵢ₋₁) and UB=Source(rᵢ₊ⱼ) and saving the candidate set, a candidate restart plan can be obtained.

However, the candidate restart plan is not necessarily equivalent to the original query plan, as illustrated by the following example. Suppose an Index Nested Loop Join is being executed between Tables A (having records 1, 2, 3, 4, 5) and Table B (having records 1, 2, 2). Consider a sliding window that includes three result tuples: r₀=(1,1), r₁=(2,2) and r₂=(2,2). The restart plan corresponding to this is defined by LB=1 and UB=2, thus leading to no record being skipped. The candidate set however has the single record r₁=(2,2), which implies that this restart plan is incorrect. Such duplication happens if and only if Source(rᵢ₋₁)=Source(rᵢ) or Source(rᵢ₊ₖ)=Source(rᵢ₊ₖ₋₁). Result windows where Source(rᵢ₋₁)≠Source(rᵢ) and Source(rᵢ₊ₖ)≠Source(rᵢ₊ₖ₋₁) are called skippable. Thus, the example window above is not skippable. The candidate restart plan corresponding to a skippable window W is denoted as RPlan(W) and the benefit of RPlan(W) as benefit(W).

An additional mechanism is employed to handle certain corner cases. Assume two “dummy” result records appearing at the root of the pipeline: a begin record associated with the iterator's Open call, and an end record associated with the call to Close. Source(begin) is defined to be zero. Source(end) is set to be the current source record being processed at the point of termination.

Consider the bounded restart plan 400 for query plan 204 in FIG. 2. Suppose that at the point of termination, no records have been output by the filter operator 206. In this case, the entire until this point can be skipped. However, a candidate restart plan is only defined for windows that have at least two corner records. Thus, begin and end are used to capture such cases.

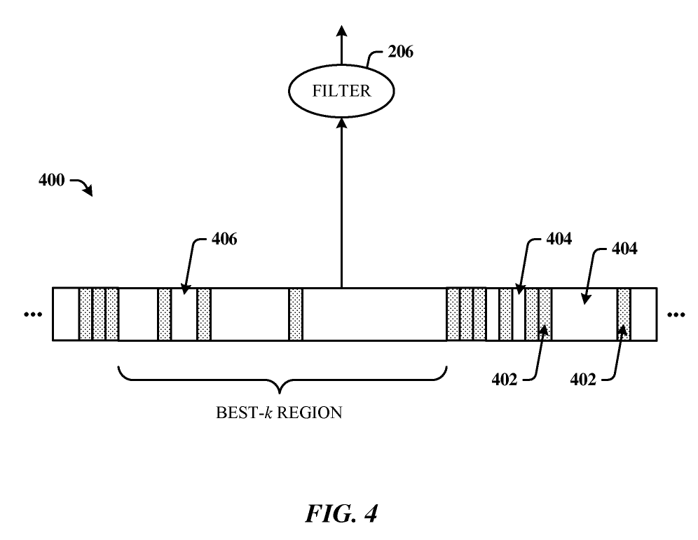

FIG. 4 illustrates an optimal bounded restart plan 400 where the budget k is three. The technique for saving all result records to obtain an equivalent restart plan described above incurs unbounded overhead (both in terms of monitoring and the stop-response-time), since the number of results generated can be large. The overhead is controlled by constraining the number of records that can be saved. A skippable window W of result records is said to be bounded if its candidate size has size at most k. The corresponding restart plan is also said to be bounded.

The bounded query checkpointing problem is the following online problem. Given a budget of k records, at any point in execution where the current source record being processed has identifier ID, the goal is to maintain a bounded restart plan equivalent to P that yields the maximum benefit among all bounded restart plans RPlan(LB,UB) with LB<UB≦ID. This is an online problem since it is unknown when the query is going to be terminated. An opt-skip algorithm is presented infra that solves the bounded query checkpointing problem.

The filtered records 402 that satisfy the filter predicate (or operator 206) are marked out. Unfiltered records 404 are those records that did not satisfy the filter operator 206. Suppose the query is terminated after all the records shown are processed. The label “Best-k Region”, where k is three, shows the region that is skipped in the optimal restart plan.

There is an inherent tradeoff between the amount of state (or intermediate records) saved and the amount of work done during restart. For a given budget k, there are cases where the maximum benefit obtainable is limited, independent of the specific algorithm used. Consider the query select * from T that scans and returns all records in T. Any algorithm can skip at most k records in the scan. If k is small compared to the cardinality of T, then most of T has to be scanned during restart.

However, in practice, there are cases where even a small value of k can yield a significant benefit provided the k records to save are carefully chosen. Even when the budget k is zero, significant benefits can be obtained. For example, in FIG. 4, the region 406 between any two successive source records that satisfy the filter predicate can be skipped.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

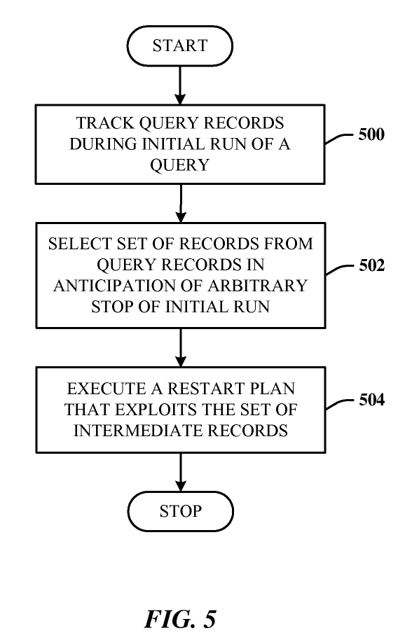

FIG. 5 illustrates a computer-implemented method of executing a query. At 500, query records received during an initial run of a query are tracked. At 502, a set of the records is selected from the query records to store in anticipation of an arbitrary stop of the initial run. At 504, a restart plan is selected and executed to exploit the set of intermediate records.

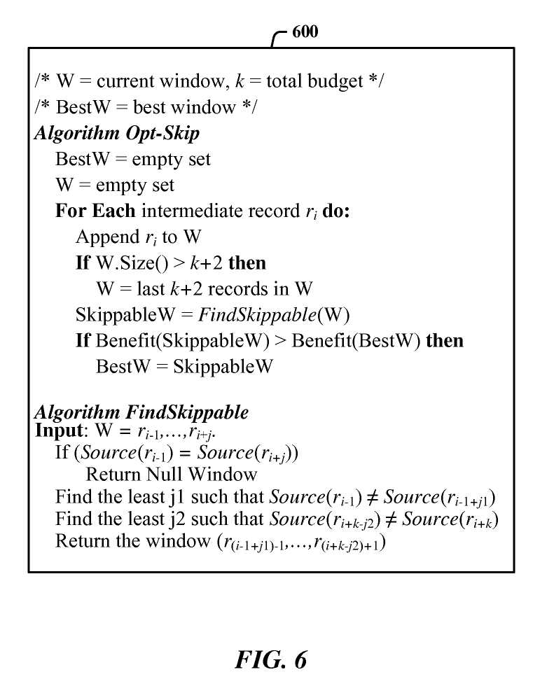

FIG. 6 illustrates an exemplary Opt-Skip algorithm 600. The Opt-Skip algorithm 600 solves the bounded query checkpointing problem described above, and is used only for single-pipelines. The algorithm 600 runs at the root node of the pipeline and considers various restart plans identified by maintaining a sliding window of result records.

A naïve strategy suggested by the problem statement above enumerates all bounded restart plans as result records arrive at the pipeline root. However, it is not necessary to enumerate all bounded restart plans. Observe that if given two restart plans RP₁=RPlan(LB₁,UB₁) and RP₂=RPlan(LB₂,UB₂), where LB₁≦LB₂ and UB₁≧UB₂, then benefit(RP₁)≧benefit(RP₂). Thus, it suffices to consider only maximal restart plans defined to be plans which are bounded and where decreasing LB or increasing UB violates the bound.

This is captured in the algorithm 600 by considering maximal skippable windows of result records. Given a window W, an extension is any window W′ that has W as a proper sub-window (so W′ has at least one more record than W). A skippable window W is said to be maximal if it is bounded and has no skippable extension that is also bounded. Maximal restart plans correspond to maximal skippable result windows, and vice versa.

The algorithm 600 enumerates restart plans corresponding to maximal skippable windows of result records. The constraint on the bound is met by maintaining a sliding window W of k+2 result records (recall that the candidate that is saved excludes the two corner records). The current window W is not necessarily skippable, which is why the method FindSkippable is invoked to find its largest sub-window that is skippable. Consider the current window of size k+2. Let it be W=rᵢ₋₁, . . . , rᵢ₊ₖ. If W is not skippable, then the largest skippable sub-window can be found by finding the least j1 such that Source(rᵢ₋₁)≠Source(rᵢ₋₁₊ⱼ₁) and the least j2 such that Source(rᵢ₊ₖ₋ⱼ₂)≠Source(rᵢ₊ₖ). (A skippable sub-window exists if and only if Source(rᵢ₋₁)≠Source(rᵢ₊ₖ).) The window returned by the FindSkippable method is (r₍ᵢ₋₁₊ⱼ₁₎₋₁, . . . , r₍ᵢ₊ₖ₋ⱼ₂₎₊₁).

Another aspect of the algorithm 600 is the computation of the benefit of a restart plan. This is computed online as follows: for result record rᵢ, let GN≦(rᵢ) be the total number of GetNext calls issued in the pipeline until the point record rᵢ was generated at the root. Let GN(rᵢ) denote the number of GetNext calls needed to generate rᵢ at the root beginning by invoking the operator tree on record Source(rᵢ) from the source. For a skippable window of result records W=rᵢ₋₁, . . . , rᵢ₊ⱼ, a benefit can be shown as,

benefit(W)=GN≦(rᵢ₊ⱼ)−GN≦(rᵢ₋₁)−GN(rᵢ₊ⱼ)

This formula enables computation of the benefit in an online fashion. In this particular implementation, focus is on pipelines that include operators such as filters, index nested loops and hash joins where GN(rᵢ) is the number of operators in the pipeline. For such pipelines, maximizing the benefit as stated above is equivalent to maximizing GN≦(rᵢ₊ⱼ)−GN≦(rᵢ₋₁). The null window referenced in the algorithm 600 is defined to have a benefit of zero.

If the number of candidate records returned at the pipeline root is less than or equal to the budget k, then all candidate records are saved. When a set of result records (intermediate results) in the current window is found that is skippable and has a higher benefit than the current best (maintained in a buffer BestW), the current best is reset with the higher benefit. The sliding window ensures that no window of records with a higher benefit is missed. It can be shown that the Opt-Skip algorithm 600 finds the restart plan with the highest benefit.

Finally, note that even though the problem statement only bounds the number of result records cached as part of the restart plan, the working memory used by Opt-Skip is also O(k).

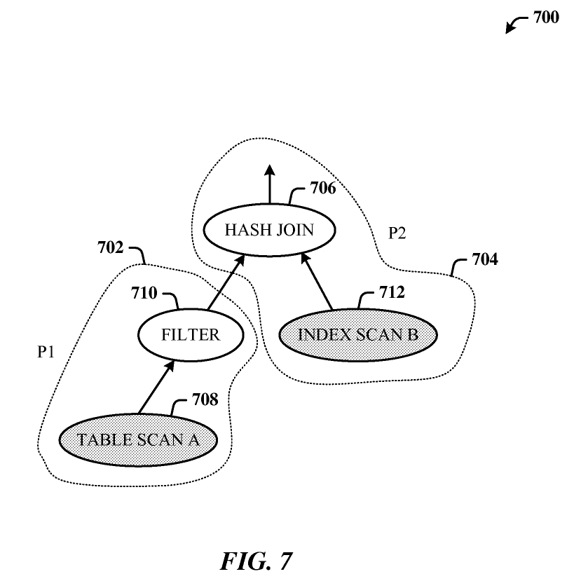

FIG. 7 illustrates an execution plan 700 with multiple pipelines. A query execution plan involving blocking operators (such as sort and hash join) can be modeled as a partial order of pipelines—called its component pipelines—where each blocking operator is a root of some pipeline. For example, the execution plan 700 includes two pipelines: a first pipeline 702 (denoted P1) and a second pipeline 704 (also denoted P2). The pipelines (702 and 704) correspond to the build side and probe side of a Hash Join operator 706, respectively. In the first pipeline 702, Table A is scanned (represented by Table Scan A 708), and the records that satisfy the selection criteria of a Filter operator 710 are used in the build phase of the Hash Join 706. The execution of the second pipeline 704 commences after hashing is finished. The index on Table B (represented as Index Scan B 712) is scanned and records are probed into the hash table for matches.

With respect to bounded query checkpointing for multi-pipeline plans, a multi-pipeline restart plan is obtained by replacing some subset of the component pipelines with corresponding single-pipeline restart plans. This preserves equivalence since replacing a pipeline with its restart plan preserves equivalence. For instance, in the execution plan 700 of FIG. 7, either pipeline 702 or pipeline 704 or both can be replaced with single-pipeline restart plans.

A goal, as with single pipeline plans, is to find a restart plan such that the total state saved, counted in terms of records, is bounded and where the cost of the plan measured in terms of GetNext calls is minimized. Again, as with single pipeline plans, the notion of the benefit of a restart plan is applied, which is the difference in the number of GetNext calls between the initial plan and the restart plan. Thus, the online problem of maintaining the restart plan that yields the maximum benefit remains.

The main difference from the single pipeline case is that for a given budget of k records, there is an option of distributing these k records among different pipelines to increase the benefit. A pipeline in an execution plan can be in one of three states: completed execution, currently executing, or not yet started. It suffices to consider pipelines that are currently executing or have completed execution for replacement with a restart plan.

Computing the optimal distribution of k records in the multi-pipeline case can require excessive bookkeeping because the optimal restart plans for different k values need to be tracked. Thus, the optimal restart plans for different values of k are tracked. This substantially increases the monitoring overhead during the initial run of the query. In order to keep this overhead low, the following heuristic approach is employed.

The BestW buffer with a budget of k records for the current pipeline is maintained. Whenever a pipeline finishes execution or the query is terminated, this buffer is merged with the buffers for the previously completed pipelines so that the overall number of records to be saved is at most k. Following are at least three methods for executing this step.

Current-Pipeline: This method retains only the BestW buffer of the currently executing pipeline and ignores the buffers corresponding to the previous pipelines. While simple to implement, this method could lead to poor restart plans, since the benefits yielded by previously completed pipelines could be significantly higher than that yielded by the current pipeline.

Max-Pipeline: In contrast with Current-Pipeline method, this method takes the benefit of the previously completed pipelines into account. The Max-Pipeline method only considers replacing a single pipeline with its optimal restart plan. Among all pipelines that are currently executing or have completed execution, the pipeline that yields the maximum benefit when replaced with a restart plan is chosen and replaced with its optimal restart plan. This is implemented as follows.

At any point, maintain the buffer corresponding to the pipelines that have completed execution. The Opt-Skip algorithm is run on the currently executing pipeline. When the current pipeline finishes execution, the benefits yielded by the buffers for the current and previous pipelines are compared and the better of the two benefits is chosen.

Merge-Pipeline: In contrast with the above two methods, the Merge-Pipeline method considers distributing the buffer space across more than one pipeline. This method can be illustrated for an execution plan that includes two pipelines. The Opt-Skip algorithm is used to compute the optimal restart plan for each pipeline independently. Consider the point where the second pipeline has finished executing. There are now two result windows cached at the roots of the two pipelines. Let these windows be represented as (r₀, r₁ . . . rₖ, rₖ₊₁) and (s₀, s₁, . . . , sₖ, sₖ₊₁). Since 2k records cannot be cached, some records should be eliminated from these windows. When desiring to eliminate one record, consideration is given to eliminating each of the four corner records r₀, rₖ₊₁, s₀, sₖ₊₁. Among these four choices, the choice that brings about the least reduction in benefit is selected. Since the budget is k, this process is repeated k times.

Sub-tree Caching: The case where the number of records returned by some node in the execution plan is less than or equal to the budget k is also considered. By saving all of these records, re-execution the whole sub-tree rooted at this node can be skipped. This is referred to as sub-tree caching. The benefit yielded by saving this set of records is set to the number of GetNext calls issued over the entire sub-tree.

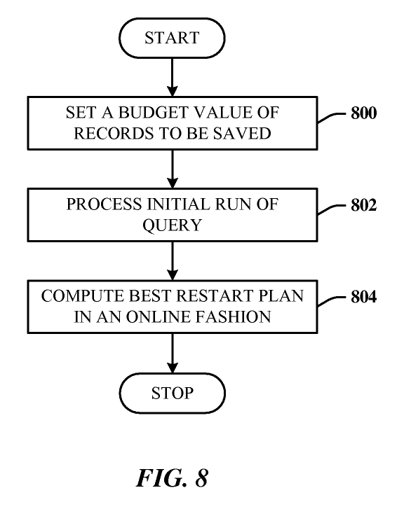

FIG. 8 illustrates a method of maintaining a maximal benefit for restart plans. At 800, a budget value of records to be saved is set. At 802, an initial query run is performed. At 804, a bounded plan having a lower bound and an upper bound is saved. At 806, the best restart plan is computed in an online fashion.

Note that a factor that can influence the benefit yielded by the skip-scan operator is the order in which records are laid out on the storage device (e.g., the hard disk drive). Thus, in FIG. 4, for example, if the records satisfying the filter predicate are evenly spaced out on disk, the benefits of bounded checkpointing may be reduced. Bounded checkpointing yields a maximum benefit when either selectivity is low or there is a strong correlation between the predicate column and the clustering column.

The overhead incurred by employing the above techniques is monitored. As previously indicated overhead has two components: the stop-response-time, which is negligible for small values of k (which can be set so that all records saved can be accommodated in a few pages), and overheads incurred in the initial run (when the query is not terminated). For a TPC-H workload, most the overheads of the queries are within 3% of the original query execution times.

The space of restart plans introduce to this point are based on the skip-scan operator. Extensions of these techniques are applicable to group-by aggregation. One of the most common operations performed in long-running decision support queries is group-by and aggregation. The disclosed algorithms handle this operation like any other operation. For example, if the number of groups output is small then subtree caching results in the entire output being saved and reused when the query is restarted.

However, this can be improved upon for group-by-aggregation, in certain cases, by saving partial state for aggregate operators. Using an example of streaming aggregation, consider a query that computes the expression sum (l_extendedprice) over a Lineitem table. During query execution, the streaming aggregation operator maintains a partial sum as a part of its internal state. An opportunity exists to persist the partial sum when the query is stopped, and during the restart, restore the internal state of aggregate operator with the saved partial sum and skip the part of the table that contributed to the partial sum. This example generalizes to the case of group-by aggregation.

Data warehouses are typically maintained periodically by running a batch of updates. Therefore, it is not unreasonable to assume that the database is static as queries are run. Following is a description of how the techniques presented herein can be adapted to the case where the database can change as the query is executed.

Whenever a query plan (involving multiple pipelines) is stopped, there is a set of pipelines which have not yet started execution. Note that if all the relations updated belong to this set and are not part of any other pipeline, the restart plan is guaranteed to be equivalent to the original plan. This observation can be used to check if the restart plan remains equivalent under updates.

A more comprehensive way of handling updates can be obtained as follows. Conceptually, think of the saved intermediate results as a materialized view and maintain the intermediate results in the presence of updates by leveraging the conventional technology on the maintenance of materialized views. Note, however, that unlike materialized views, the state persisted is captured using system-generated RID values that are not visible at the server level (e.g., SQL). The database system can be extended to introduce the notion of system-materialized views which are not necessarily visible in a database such as SQL.

One extension to the bounded query checkpointing problem is to enable the handling of disk “spills”. Additional logic is needed to check equivalence of restart plans in the presence of hash spills. Consider an example Hash Join where the build relation is too large to fit in main memory. In this case, the join spills one or more hash partitions to disk. Assume the query execution is in the probe phase and the best-k records are being computed to save at the output of the join. A probe-side source record for which no match is found in any of the in-memory partitions cannot be skipped, since all the result records produced by any skipped source record should be saved.

While a complete solution for handling spills can be complex, two straightforward methods can be utilized. One is to enhance the FindSkippable method (the algorithm 600 of FIG. 6) to incorporate spills. Thus, any window of records that has records that hash to a spilled partition is regarded as not skippable. An alternative approach is to disallow saving results produced by operator nodes that can potentially spill, such as hash join and hash-based group-by. Thus, for the example above, only the results produced by the filter below the hash join are saved and this is used to skip appropriately.

It is assumed in this description that the query plan used when the query is restarted is exactly the same plan used in the initial run, modulo replacing table scans with skip-scans. However, since large portions of the base tables could potentially be skipped, additional benefits can be obtained by re-invoking the optimizer when the query is restarted. For example, suppose that records are being skipped on the probe side of a hash join. During restart, fewer records are read from the probe-side table so that it is more efficient to perform an index nested loop join.

The disclosed techniques can also be beneficial in the context of “pause and resume” implementations for pipelines whose root is a blocking operator such as a build phase of a hybrid hash join. Further, there are many scenarios where the stop-restart model of execution is more appropriate. For example, a large class of 3-tier database applications is architected to be stateless—in the event of failures (e.g., application crashes, connection or SetQueryTimeOut in ODBC (open database connectivity)), the databases simply start afresh.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

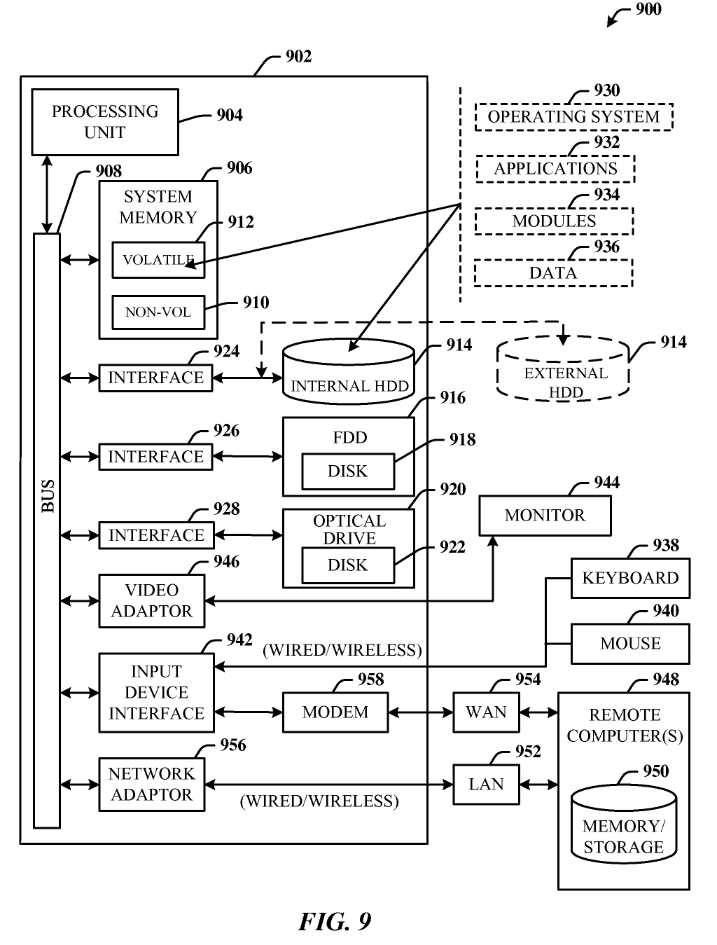

Referring now to FIG. 9, there is illustrated a block diagram of a computing system 900 operable to execute the disclosed stop-and-restart execution plan architecture. In order to provide additional context for various aspects thereof, FIG. 9 and the following discussion are intended to provide a brief, general description of a suitable computing system 900 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 9, the exemplary computing system 900 for implementing various aspects includes a computer 902 having a processing unit 904, a system memory 906 and a system bus 908. The system bus 908 provides an interface for system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 can include non-volatile memory (NON-VOL) 910 and/or volatile memory 912 (e.g., random access memory (RAM)). A basic input/output system (BIOS) can be stored in the non-volatile memory 910 (e.g., ROM, EPROM, EEPROM, etc.), which BIOS contains the basic routines that help to transfer information between elements within the computer 902, such as during start-up. The volatile memory 912 can also include a high-speed RAM such as static RAM for caching data.

The computer 902 further includes an internal hard disk drive (HDD) 914 (e.g., EIDE, SATA), which internal HDD 914 may also be configured for external use in a suitable chassis, a magnetic floppy disk drive (FDD) 916, (e.g., to read from or write to a removable diskette 918) and an optical disk drive 920, (e.g., reading a CD-ROM disk 922 or, to read from or write to other high capacity optical media such as a DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 912, including an operating system 930, one or more application programs 932, other program modules 934, and program data 936. The one or more application programs 932, other program modules 934, and program data 936 can include the selection component 102, execution component 108, and algorithm 600, for example. All or portions of the operating system, applications, modules, and/or data can also be cached in the volatile memory 912. It is to be appreciated that the disclosed architecture can be implemented with various commercially available operating systems or combinations of operating systems.

A user can enter commands and information into the computer 902 through one or more wire/wireless input devices, for example, a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, etc.

A monitor 944 or other type of display device is also connected to the system bus 908 via an interface, such as a video adaptor 946. In addition to the monitor 944, a computer typically includes other peripheral output devices (not shown), such as speakers, printers, etc.

The computer 902 may operate in a networked environment using logical connections via wire and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, is connected to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for query execution, comprising:
a selection component for selecting a subset of state associated with an initial run of a query that is abnormally terminated; and
an execution component for restarting execution of the query based on a restart plan and skipping execution of the subset during the restart plan.

2. The system of claim 1, wherein the restart plan is a multi-pipeline plan the execution of which retains a best buffer of a currently executing pipeline and ignores buffers of previously completed pipelines.

3. The system of claim 1, wherein the restart plan is a multi-pipeline plan the execution of which retains a best buffer among all pipelines that have completed execution and a currently executing pipeline.

4. The system of claim 1, wherein the restart plan is a multi-pipeline plan the execution of which merges buffers among all pipelines that have completed execution and a currently executing pipeline, based on available buffer space and a least reduction in benefit.

5. The system of claim 1, wherein the restart plan includes a skip-scan operator that scans all records in a source node up to a lower bound record of the subset and restarts execution at an upper bound record of the subset.

6. The system of claim 1, wherein the subset of state skipped includes at least one contiguous portion of records scanned by an operator.

7. The system of claim 1, wherein the size of the subset is bounded to limit resources retained by the query and to reduce overhead processing.

8. The system of claim 1, wherein the query is a long running decision support query.

9. The system of claim 1, wherein the subset of state is selected dynamically as execution proceeds based on a sliding window of result records.

10. The system of claim 1, wherein the selection component chooses the subset based on a maximum benefit among all bounded restart plans.

11. A computer-implemented method of executing a query, comprising:
tracking query records received during an initial run of a query;
selecting a set of intermediate records from the query records to store in anticipation of an arbitrary stop of the initial run; and
executing a restart plan that exploits the set of intermediate records.

12. The method of claim 11, further comprising limiting size of the set of intermediate records that can be saved and reused during the restart run.

13. The method of claim 11, further comprising skipping records between successive source records in an execution plan of a single pipeline corresponding to the set of intermediate records saved for reuse at a root of the single pipeline.

14. The method of claim 11, further comprising selecting the set of intermediate records dynamically as execution proceeds, based on a sliding window of result records.

15. The method of claim 11, further comprising checking for correctness of the restart plan by determining if a candidate window of the set of intermediate records is skippable.

16. The method of claim 11, further comprising computing a benefit of the restart plan based on a number of GetNext calls skipped.

17. The method of claim 11, further comprising saving all of a number of candidate intermediate records returned at a pipeline root when the number is less than or equal to a budget value of records.

18. The method of claim 11, further comprising storing partial state of aggregate or group-by operators when a corresponding current number of computed aggregates or number of groups is less than or equal to a budget value of records.

19. The method of claim 11, further comprising replacing a current best window with a new current best window based on the new current best window having a skippable set of the intermediate records and a higher benefit than the current best window.

20. A computer-implemented system, comprising:
computer-implemented means for tracking query records received during an initial run of a query;
computer-implemented means for selecting a set of the records from the query records to store in anticipation of an arbitrary stop of the initial run; and
computer-implemented means for skipping over the selected set of the records during a scan process of a restart run of the query.
